(19) United States
(12) Patent Application Publication
(10) Pub. No.: US 2021/0388676 A1
(43) Pub. Date: Dec. 16, 2021

(54) MOTORIZED LADDER ASSEMBLY

(71) Applicant: Jarvis D. Jones, SR., Chicago, IL (US)

(72) Inventor: Jarvis D. Jones, SR., Chicago, IL (US)

(21) Appl. No.: 17/307,801

(22) Filed: May 4, 2021

Related U.S. Application Data
(60) Provisional application No. 63/101,599, filed on May 8, 2020.

(51) Int. Cl. E06C 7/16

(52) U.S. Cl. CPC E06C 7/16; E06C 7/12

(57) ABSTRACT

A motorized ladder assembly for ascending and descending from a height safely. The motorized ladder assembly includes an A-shaped frame having a front member and a rear member forming the A-shape. Each front member and the rear member having a pair of parallel rails. The main step is horizontally bridged between the pair of rails of the front member and mounted to a track of a drive mechanism configured for ascending and descending the main step between a top end and a bottom end of the front member. A platform having a base and an upstanding pair of handrails that extends from the ends of the base. The base can be coupled to the main step, such as the base and the main step are coplanar. The pair of handrails run parallel and adjacent to the pair of rails of the front member.

### CROSS-REFERENCE TO RELATED APPLICATIONS

This present application claims priority from a U.S. provisional patent application Ser. No. 63/101,599 filed May 8, 2020, which is incorporated herein by reference in its entirety.

### FIELD OF INVENTION

The present invention relates to a motorized ladder assembly, and more particularly the present invention relates to a motorized ladder assembly for motorized ascending and descending a height.

### BACKGROUND

A Ladder is an important tool for climbing up to reach a height for something. A ladder is also an important tool in home improvement. A-shape ladders, also known as step ladders, are most common in homes because of their portability and ease of use. Ladder-related injuries are also common. According to the World Health Organization, the United States leads the world in ladder deaths. Each year, there are more than 164,000 emergency room-treated injuries and 300 deaths in the U.S. that are caused by falls from ladders. According to the American Academy of Orthopedic Surgeons, every year 500,000 people are treated for ladder-related injuries. Some of the common reasons for ladder-related injury are improper mounting of the ladder or mis-stepping while climbing or descending. Despite the ladder-related injuries are increasing every year, there is no good substitute for a ladder.

Thus, a desire is there for a safe substitute of a ladder that can be used to safely climb up and down from a height.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a motorized ladder assembly for safely ascending and descending a height.

It is another object of the present invention that a person ascends and descends a ladder without physical exertion.

It is still another object of the present invention that the motorized ladder assembly helps increase the productivity of a user.

It is yet another object of the present invention that the motorized ladder assembly makes climbing a height easier and faster.

It is a further object of the present invention that the motorized ladder assembly is portable.

In one aspect, disclosed is a motorized ladder assembly for safely ascending and descending a height without the risk of falling or slipping from the ladder. Disclosed motorized ladder assembly includes a frame resembling a step ladder, in which a drive mechanism can move the steps of the ladder up and down along the length of the ladder. A drive mechanism can be mounted within the frame and includes a track on which the steps can be mounted. The track can be driven by an electric motor also mounted to the frame. Suitable controls can be provided to operate the drive mechanism, such as turning the power to the drive mechanism on and off. A platform including a base and a pair of handrails can be coupled to one of the steps that are coupled to the drive mechanism.

In one aspect, suitable sensors and alarms can also be equipped in the disclosed motorized ladder assembly for its safe operation. The sensors and alarms can indicate any erroneous operation, mishandling, or uninvited approaching of person, child, or pet towards the motorized ladder assembly. The controls can be shielded by a cover for child safety. The sensors can include an IR sensor, proximity sensor, and like. The alarms can include light indicators, blinking LEDs, and audio alarms. The sensors can automatically cease the drive mechanism when any aforesaid alarming situation can be detected.

In one aspect, the steps of motorized ladder assembly can include projecting rods at opposite ends of the step. Fixed gears can be coupled to the endpoints of the projecting rods. The gears allow the steps to be mounted to a chain installed within the poles of the frame. The chain can be driven by the electric motor also mounted to the frame. The electric motor can be powered by a rechargeable battery, the rechargeable battery and the electric motor are enclosed within the housing of the frame.

These and other objects and advantages of the embodiments herein and the summary will become readily apparent from the following detailed description taken in conjunction with the accompanying drawings

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a perspective view of a motorized ladder assembly, according to an exemplary embodiment of the present invention.

FIG. 2 shows the housing of the motorized ladder assembly, according to an exemplary embodiment of the present invention.

FIG. 3 shows a person on the platform of the motorized ladder assembly, according to an exemplary embodiment of the present invention.

FIG. 4 shows the person on the platform shown in FIG. 3 ascended to a height, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

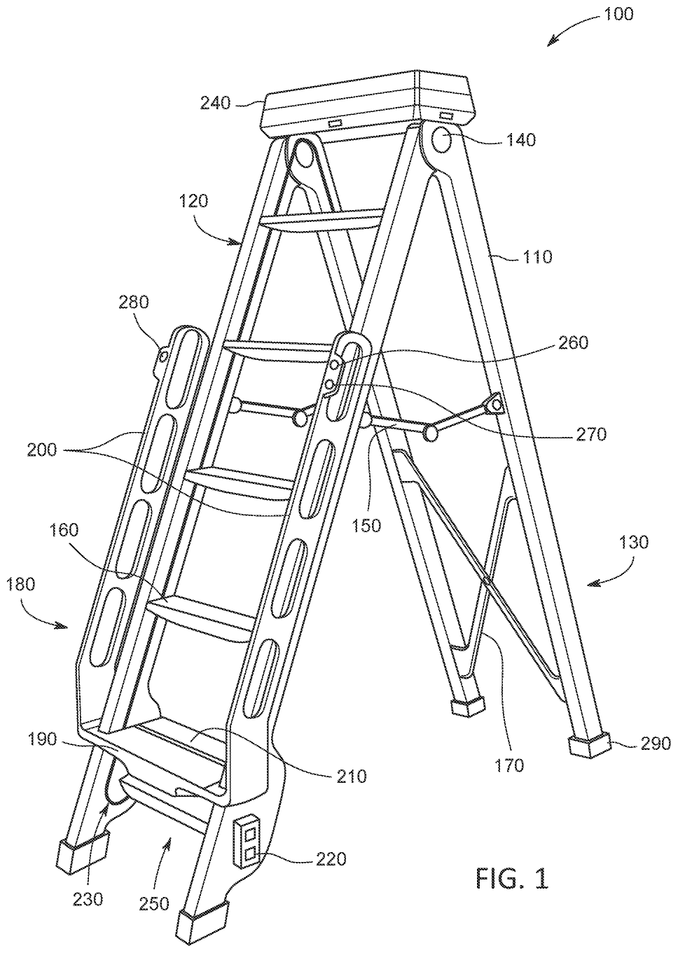

Referring to FIG. 1 which shows the disclosed motorized ladder assembly 100 that can assist a person to ascend or descend from a height safely and without physical exertion. Referring to FIG. 1, which shows the motorized ladder assembly 100 that can include an A-shape frame 110 having a front member 120 and a rear member 130 that can be coupled at their top ends while the bottom ends are separated to form the A-shape. The joint 140 that couple the front member 120 to the rear member 130 can be a hinge joint 140 that may allow the front member and the rear member to be folded and unfolded. A two-piece spreader 150 can also be provided to restrict the A-shape member in the unfolded configuration supported on the ground.

Each front member 120 and the rear member 130 can have a pair of rails that run parallel to each other. The front member 120 can have multiple rungs 160 horizontally bridging the two parallel rails of the front member 120. The rear member 130 can also have one or more rungs bridging the two parallel rails. Alternatively, a cross-spline can support the two parallel rails of the rear member 130. FIG. 1 shows the front member 120 having spaced rungs 160 along the length of the front member 120. The rear member 130 having a pair of cross splines 170 supporting the two parallel rails.

A platform 180 can be seen in FIG. 1 mounted to the front member 120 of the A-shape frame 110. The platform 180 can have a base 190 and a pair of upstanding handrails 200 that extends from the ends of the base 190. The pair of handrails 200 run parallel and adjacent to the pair of rails of the front member 120. The base 190 can be coupled to one of the steps of the front member 120. FIG. 1 shows the base 190 coupled to a main step 210, such as the base 190 and step 210 can be coplanar. The top surface of base 190 and step 210 can be parallel to the ground, such as a person can comfortably stand on the base 190 and/or step 210. In one case, the base 190 can be removably coupled to the main step 210. In one case, the base 190 can be integral to main step 210.

The length of the handrails 200 can be proportional to the height of an average adult's chest above ground, such as an adult person of an average height can stand upright on the base 190 of the platform 180 and can comfortably grip the handrails 200 without bending. The handrail can be strong enough to support a person standing on the platform.

The motorized ladder assembly 100 can include a drive mechanism that can move the steps of the front member 120 up and down along the length of front member 120. Each step can include projecting rods at the opposite ends, such as the step can be mounted to the drive mechanism. The drive mechanism can include a chain that runs within the frame i.e., within the pair of rails of the first member. The steps of the first member can be mounted to the chains through a suitable gear mechanism. The chains can be driven by an electric motor also mounted on the frame, such as on the top of the frame.

FIG. 1 shows a gap 230 within the rails of the front member 120 of the frame 110. The projecting rods of the steps can traverse through this gap and be mounted to the drive mechanism. The electric motor of the drive mechanism can be encased in the housing 240 also mounted on the top of the frame 110. The electric motor can be powered by a rechargeable battery also enclosed within the housing 240. The rechargeable battery can be charged by an external power source.

It can be seen that the front member is having multiple steps. At least one step can be provided below the main step 210 and at least one step can be provided above the main step 210. The steps above and below the main step 210 may allow a person standing on the base 190 to rest a foot for adjusting the body posture while reaching for something. Multiple steps can be provided above and below the main step 210. The drive mechanism allows steps to be stacked at the bottom of the front member and/or the top of the front member. FIG. 1 shows a stack of steps 250 below the main step 210. The drive mechanism can include a track that runs along the length of the opposite rails of the front member. The steps can be mounted to the track which moves the steps up and down along the length of the opposite rails. The track provides for moving a step from the stack of steps 250 at intervals providing the desired space between two adjacent steps. In one case, the track can be continuous from the front member to the rear member of the frame. The steps of the front member instead of stacking at the top can be moved along the track to the rear member. The play of the track can be such as the main step 210 can move between the top and bottom of the front member 120, such as a person standing on the base 190 of the platform 180 can ascend and descend between the bottom and top of the front member along the length of the front member 120 of the frame 110.

A power switch 220 can be seen at bottom of the front member. The power switch 220 can have two buttons to control the power supply to the drive mechanism of the motorized ladder assembly 100. Two buttons i.e., an on button and an Off button can be provided that allows turning the power supply to the drive mechanism on and off. The “on” bottom can be colored green while the “stop” button can be colored red. The “stop” button can also be used in an emergency to immediately stop the drive mechanism. The power switch can be having a protective cover for child safety.

The platform 180 can also have buttons near the top of the handrails 200 within reach of a person standing on the platform. Such a button allows the person to move the platform up and down. Two buttons on the right handrail can be an up button 260 and a stop button 270. The up button 260 engages the drive mechanism moving the steps up i.e., the ascending motion of the steps. A stop button 270 can be pressed by the person for stopping the platform at the desired position. On the other handrail of the platform can be seen another button “down” that can be used to move the platform downwards i.e., descend on the frame. The stop button can be used to stop the descend at the desired height. Alternatively, the stop button can be omitted, wherein the up button or the down button can be kept pressed for moving the platform. Releasing the buttons stops the drive mechanism. FIG. 1 also shows the bottom end of the front member and rear member having rubber stoppers 290. The rubber stopper can provide grip on the floor and prevent slipping of the motorized ladder assembly 100 on the floor. Suitable retractable wheels can also be provided on at least the front member or the rear member that may allow moving the ladder assembly.

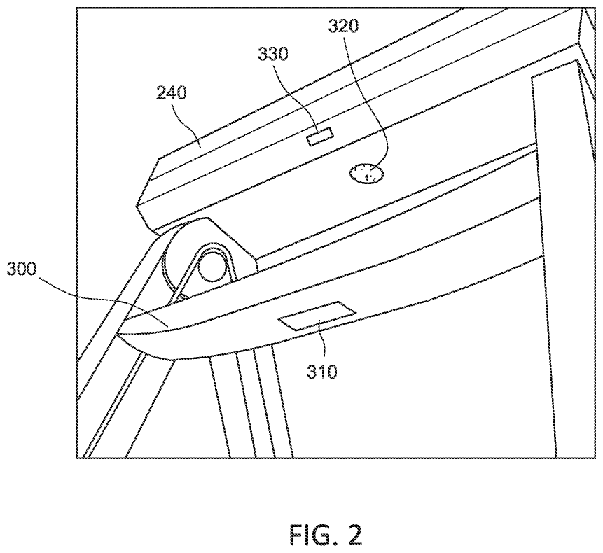

In one exemplary embodiment, suitable sensors can also be provided to detect any irregularity, such as shaking of the frame or miss-stepping. The sensors can be provided on the bottom surface of the steps of the front member 120. Referring to FIG. 2 which shows a step 300 having a sensor 310 on the bottom surface of step 300. The sensor can be an IR sensor, proximity sensor, and like that can detect a person or child coming near or passing the ladder and on detecting person or child can stop the ladder to prevent any accident. The housing 240 can also be provided with a speaker 320 and LED indicators 330 to raise alerts or alarms. For example, when the platform is about to reach the top end or the bottom end of the front member, the alarm can be triggered to alert the person on the platform 180.

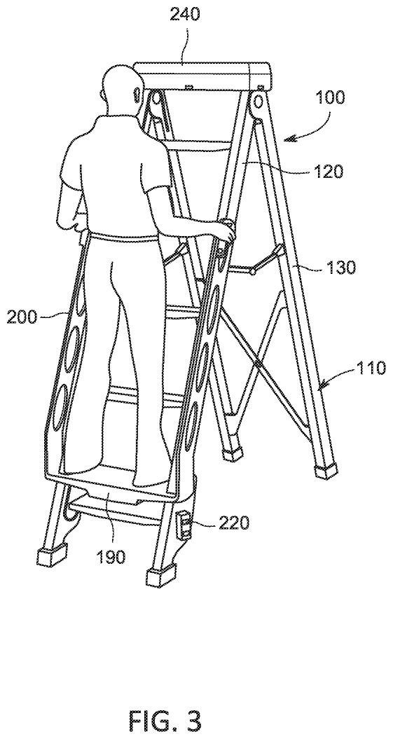

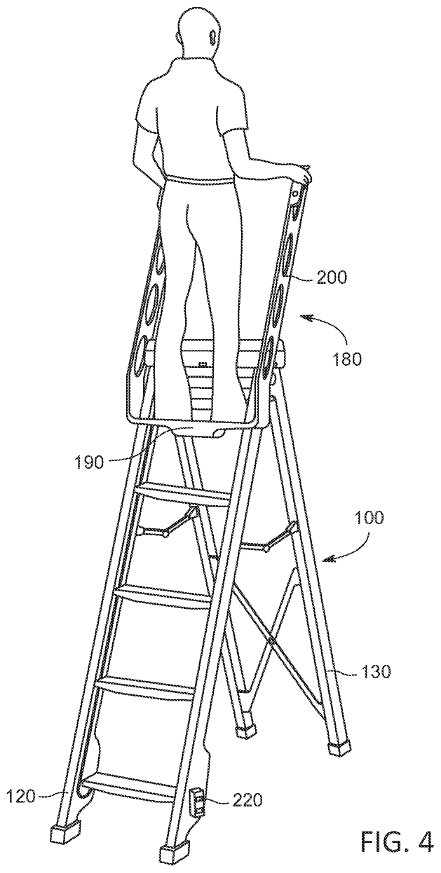

Referring to FIG. 3 which shows a person standing on the base of the platform and grip the handrails. The person can be seen in a comfortable upright position with the control buttons on the handrail within reach of the person. The person can press the up button which causes the platform to ascend till it reaches the top end. The person can stop the platform at the desired height by pressing the stop button. FIG. 4 shows the person standing on the platform ascended to the top end. The handrails can bypass the top plate of the frame and can provide support to the person while working.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A motorized ladder assembly comprising:
a A-shaped frame having a front member and a rear member, each the front member and the rear member having a pair of parallel rails,
a main step horizontally bridged between the pair of parallel rails of the front member, the main step mounted to a track of a drive mechanism configured for vertically moving the main step up and down along the length of the front member; and
a platform comprising a base and upstanding pair of handrails that extends from ends of the base, the base coupled to the main step, such as the base and the main step are coplanar, the pair of handrails runs parallel and adjacent to the pair of parallel rails of the front member.

2. The motorized ladder assembly according to claim 1, wherein front member further comprises at least one upper step above the main step mounted to the track and bridged between the pair of parallel rails of the front member, and at least one lower step below the main step mounted to the track and bridged between the pair of parallel rails of the front member.

3. The motorized ladder assembly according to claim 2, wherein the at least one upper step, the main step, and the at least one lower step are spaced equally from each other.

4. The motorized ladder assembly according to claim 1, wherein a first button and a second button are provided near top of the handrails of the platform, the first button on actuation results in ascending of the platform and the second button on actuation results in descending of the platform.

5. The motorized ladder assembly according to claim 1, wherein a height of the pair of handrails is about 2-4 feet.

6. The motorized ladder assembly according to claim 1, wherein the track is installed within the pair the parallel rails of the front member.

7. The motorized ladder assembly according to claim 6, wherein the drive mechanism comprises an electric motor operably coupled to the track, the electric motor mounted to the frame.
